(19) United States
(12) Patent Application Publication
(10) Pub. No.: US 2011/0167327 A1
(43) Pub. Date: Jul. 7, 2011

(54) Method for preparation of a digital document for the display of said document and the navigation within said

(76) Inventors: Joris Roussel, Paris (FR); Estelle Bredzinski, Paris (FR)

(21) Appl. No.: 12/737,171

(22) PCT Filed: Jun. 18, 2009
(86) PCT No.: PCT/EP2009/057624

§ 371 Date: Dec. 14, 2010

(51) Int. Cl. G06F 17/00; G06F 3/01

(52) U.S. Cl. 715/201

(57) ABSTRACT

The present invention relates to a method for preparation of a digital document for the display of said document and the navigation within said document in a mobile device, said display and navigation operations being realized by a computer program, said document comprising a plurality of elements and at least one page characterized in that it comprises the following steps: upon the reception of the document: pre-interpretation of the digital document and encoding of a part at least of the elements of said digital document into objects directly exploitable by said computer program; upon reception of a display command of a page of the digital document: identification of the tasks associated with this page and creation of a reference table pointing directly to the objects describing the tasks of said page, and displaying of said page comprising a possible highlighting of objects that can be activated and/or a possible scrolling of the page, then execution of the tasks upon request of a user.

### FIELD OF THE INVENTION

The present invention relates to the field of information technologies.

The present invention relates more specifically to the domain of software environments, and notably navigators, that is to say computer programs intended for the display of digital documents and for navigation within such digital documents.

### BACKGROUND ART

Some known portable communication devices, such as for example but not restricted to terminals in conformance with the DECT (Digital Enhanced Cordless Telecommunications) standard, have limited resources and the following technical and usage constraints:
low level of available calculating power,
reduced RAM (Random Access Memory) memory,
standard content languages support, such as for example WML (Wireless Markup Language), and
rapid navigation.

In contrast with terminals possessing high calculation capacities and comprising a native navigator loaded in the terminal, the devices of the type above comprise limited resources and often must use the calculating power of a server or of a gateway, to which it is connected.

The devices known in the art that have limited resources, of the type mentioned above, do not generally properly support the display of digital documents and navigation within such digital documents.

It is noted that a document of a known type in conformance with WML language is a set of pages (“Cards”) grouped together in an element called a “Deck”.

The prior art knows, through the American patent application US 2004/0133848 (Novarra), a system and method for the provision and display of content. This American patent application describes a solution consisting in a navigator distributed between a server and a platform.

The prior art also knows, through the patent application PCT WO 2003/054733 (Nokia) a method aiming to extend the possibilities of XHTML language to add to it certain specific functions of WML language.

### SUMMARY OF THE INVENTION

Navigation in digital pages is composed in one part of navigation within a page and, in another part, of jumps between pages. Navigation within a digital page is itself broken down between scrolling operations, and actions and tasks linked to page objects.

One purpose of the present invention is to enable the integration of a native navigator within a device comprising limited resources, specifically in terms of calculating power.

Another purpose of the present invention is to minimise as much as possible the CPU (processor) load of the navigator and limit the memory consumption. The distribution of the load according to the frequency of operations enables the reactivity of the navigator to be optimized to the maximum. In fact, the navigator is all the more reactive as the load is low.

For this purpose, the present invention relates, in its most generally accepted sense, to a method for preparation of a digital document for the display of said document and the navigation within said document, said display and navigation operations being realized by a computer program, said document comprising a plurality of elements and at least one page characterized in that it comprises the following steps:
upon the reception of the document: pre-interpretation of the digital document and encoding of a part at least of the elements of said digital document into objects directly exploitable by said computer program,
upon reception of a display command of a page of the digital document: identification of the tasks associated with this page and creation of a reference table pointing directly to the objects describing the tasks of said page, and
displaying of said page comprising a possible highlighting of objects that can be activated and/or a possible scrolling of the page, then execution of the tasks upon request of a user.

Preferably, the pre-interpretation step of the digital document and the encoding of a part at least of the elements of said digital document are composed of two sub-steps: one of formatting of the display and the other of formatting of the tasks.

Advantageously, the display formatting sub-step consists in page formatting the document set so that all parts of said document can be directly displayed without requiring a page re-formatting.

According to a particular embodiment, the pre-interpretation step of the digital document and the encoding of at least part of the elements of said digital document are executed by applying a rule according to which an object is replaced by another object occupying at most the same space in memory.

According to a variant, the overlapping of displayable objects and non-displayable objects is conserved without having any impact on the display and task identification functions.

According to an embodiment, said method comprises a step of suppression of elements of said document that are neither displayable, nor identifiable as tasks, and a step of resetting to zero of the corresponding memory space. This enables the acceleration of the navigation in said document.

According to a particular variant, said method comprises a step of concatenation of elements framing an unused memory zone. This enables the liberation of memory for other applications.

The method according to the present invention enables in particular to balance the load at processor level without increasing the impact on the memory, and all while assuring very good performances in terms of navigation.

### BRIEF DESCRIPTION OF THE DRAWINGS

The invention will be better understood from the following description of an embodiment of the invention provided as an example by referring to the annexed figures, wherein:

FIG. 1 represents a portable item of equipment,

FIG. 2 illustrates the method according to the present invention, an

FIGS. 3, 4 and 5 are diagrams showing the steps of the method relating respectively to the pre-interpretation of the document, to the initialization of the navigator and to the navigation within the document.

### DETAILED DESCRIPTION OF THE EMBODIMENTS OF THE INVENTION

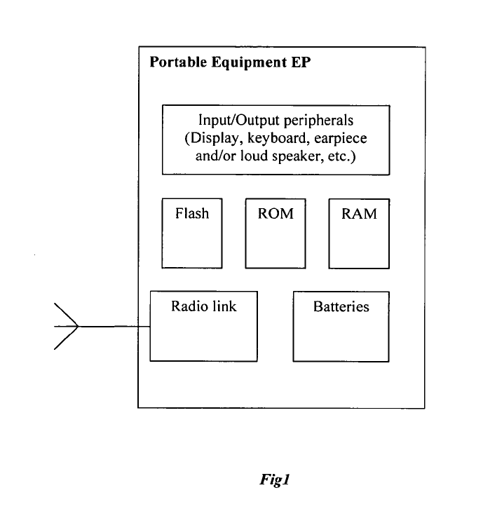

The EP portable equipment, shown in FIG. 1, comprises the following elements and function:
a set of input/output peripheral devices: display, keyboard, earphone and/or loud-speaker
a processor (not represented),
a non-volatile memory containing the code and the software data ensuring the operation of the equipment,
a volatile memory (RAM) containing data that is “variable” in time,
a wireless data link (that can serve as voice support in the case of a telephone),
a battery ensuring the power supply of the equipment.

This portable equipment is, in an exemplary embodiment, a telephone handset according to the DECT standard or any kind of mobile device.

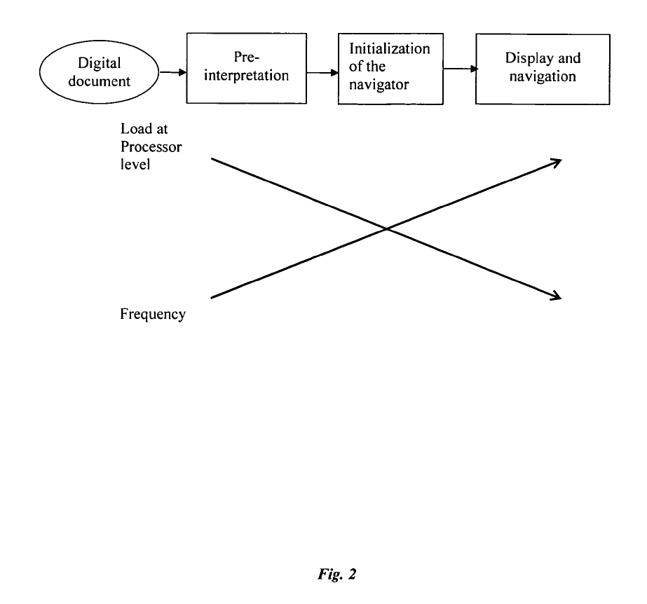

FIG. 2 shows the different steps of the method according to the invention. This method comprises three steps:
1) Pre-interpretation (or “Preparsing”)
2) Navigator initialization (or “Browser init”)
3) Display and navigation (“Display and browse”)

It can be seen on FIG. 2 that the load at processor level diminishes and that the frequency of processing operations increases as the steps of the method are executed.

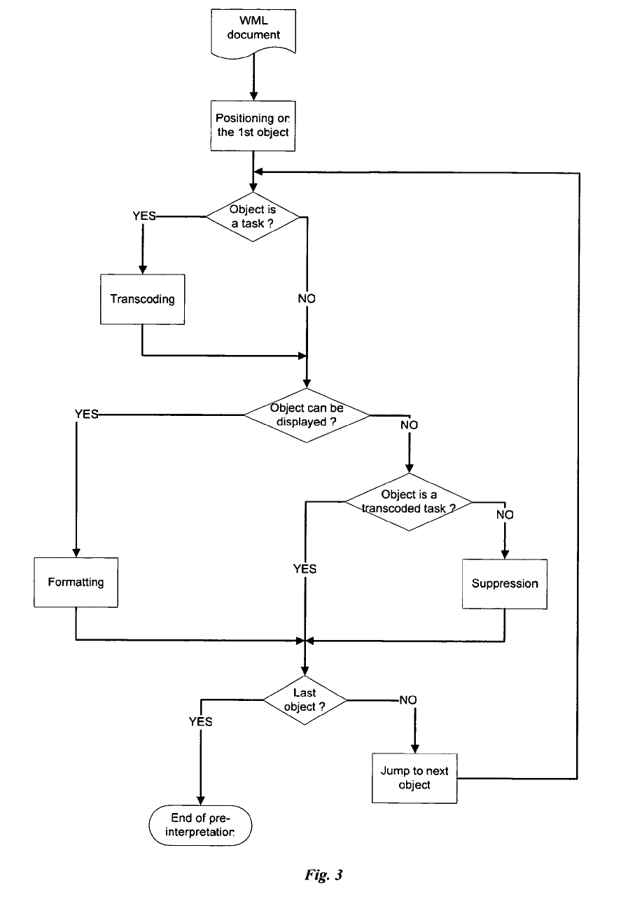

The pre-interpretation or “Preparsing”, shown in FIG. 3, is executed once, upon reception of the document. This step is a heavy user of CPU resources but has no impact at memory level, beyond the initial storage of the document.

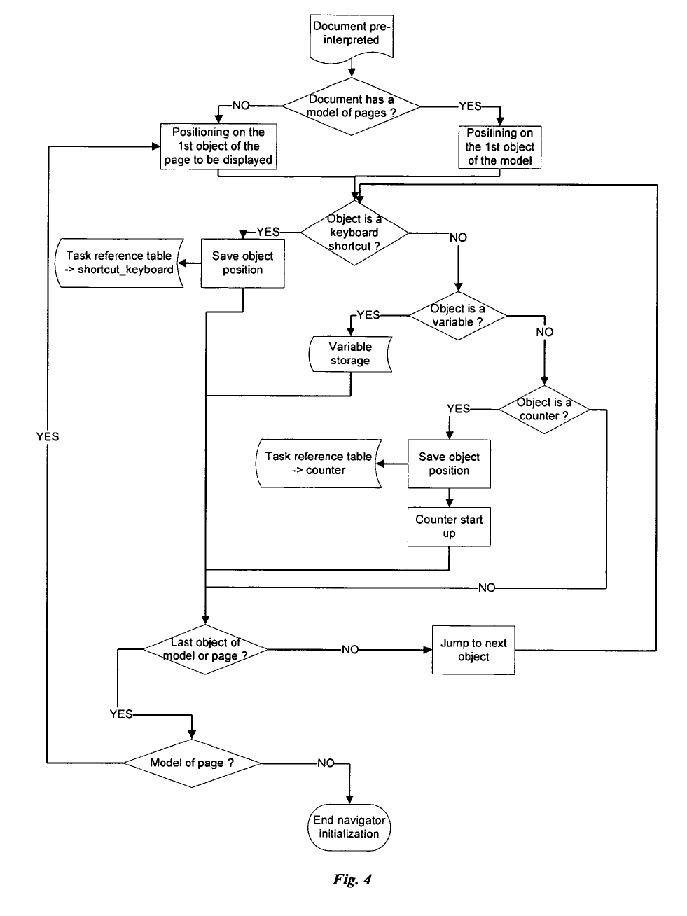

The processing relating to initialization of the navigator (“Browser init”), shown in FIG. 4, is carried out when a page must be displayed. It is therefore executed at each page change but, according to an embodiment, not during navigation within a page. Its purpose is to isolate the tasks linked to a page (timers, tasks linked to keys, object linked to an action) in order to accelerate the execution (no need to carry out parsing completely on a page when an event occurs).

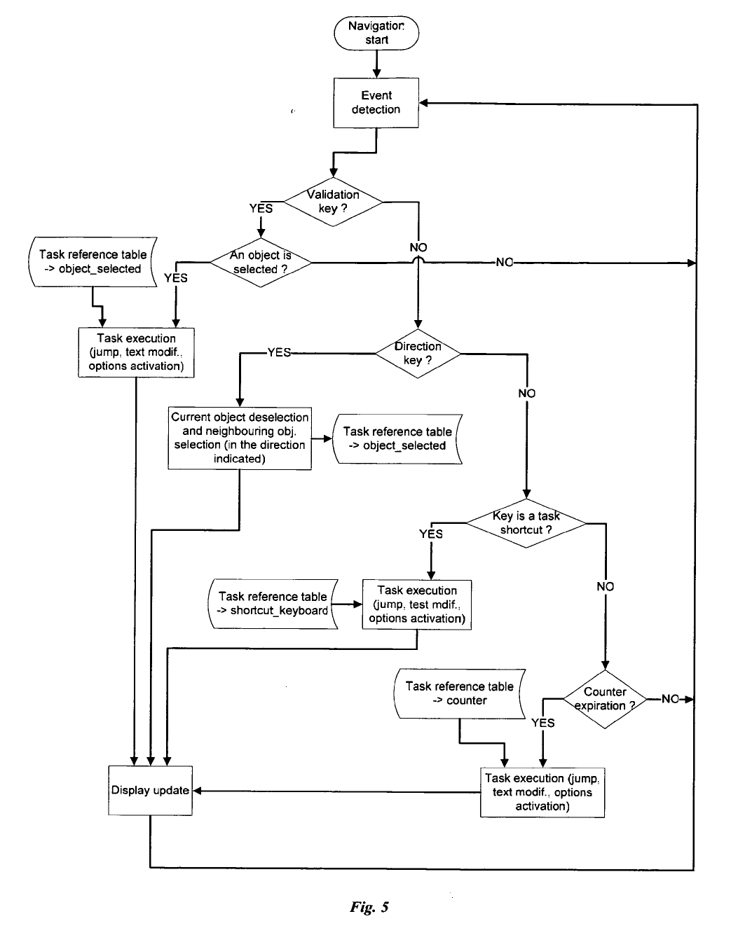

The processing relating to the displaying and to the navigation (or “Display and browse”), shown in FIG. 5, is the processing of navigation within a page. As the pagination and the identification of tasks have already been carried out, the highest frequency of its use has a minimum impact on the CPU load and is very responsive for the user.

What distinguishes this solution from existing solutions is this splitting into three steps in order to redistribute the CPU load, while rendering quasi-null the memory impact of the navigator in its entirety.

1) Pre-Interpretation (or “Preparsing”):

This pre-interpretation or “preparsing” step is executed once, upon reception of the document. It is shown in FIG. 3.

This step implements the following principle:

Each element is pre-interpreted and replaced by objects occupying at maximum the same memory space. This principle is called the “non-overflow rule”, this name making reference to the fact that each object is replaced by another object having at worst the same memory impact.

The advantage of this operation is not the reduction of memory space required but the pre-interpretation of the document and the encoding into objects that can be exploited directly by the portable equipment and with a null memory consumption.

This step is composed of two sub-steps:

a) Formatting of the Display (or “Display Formatting”):

This processing consists in page formatting the entire document so that each part of said document can be directly displayed without requiring the page to be re-formatted, contrary to existing solutions.

The document is thus cut into lines that can be entirely displayed and according to the non-overflow rule. Only the elements that can be displayed are taken into account in the page formatting.

For example in the scope of a page not comprising an object that can not be displayed:
Pre processing: “Master crow, on a tree perched”
Post processing: “Master crow, on” Return “a tree perched”
For example in the scope of a page comprising an object that can not be displayed:
Pre processing: “Master crow, <object that can not be displayed> on a tree perched”
Post processing: “Master crow, <object that can not be displayed> on” Return “a tree perched”

b) Formatting Tasks (or “Task Formatting”):

This processing consists in identifying objects reacting to events (keyboard shortcuts, timers, objects that can be selected, etc.) and transcoding them so that they can be directly interpreted by the computer program, possibly integrated in a portable equipment such as a handset. This processing will enable the rapid extraction of events to be monitored when loading a page (initialization of the navigator or “Browser init”).
Example: definition of a jump associated with the key A
Pre processing: <do type=“A” label=“options”><go href=“weather_card”/></do>
Post processing: shortcut_opcode(1B) key_opcode(1B) A label_opcode options jump_opcode weather_card end_shortcut_opcode(1B)
It can be noted that the set of these two operations is characterized by the fact that the overlapping of objects that can be displayed and objects that can not be displayed (defining a task) is conserved without having any impact on the display functions and on the identification of tasks.

This step of pre-interpretation is shown in FIG. 3: a document, for example of WML type, is pre-interpreted: the first object is positioned upon, then it is determined if this object corresponds to a task or not. If the object indeed corresponds to a task, a transcoding sub-step is carried out. It is then determined if this object can be displayed or not. If it can be displayed, a page formatting sub-step is carried out. If it can not be displayed and if it does not correspond to a task, this object is suppressed. Then, one passes to the next object of the digital document in question and the same processing operations will be carried out on the next object, or, if the object processed is the last object of the page, this pre-interpretation step is ended.

2) Navigator Initialization (or “Browser Init”):

This processing operation, shown in FIG. 4, consists in identifying the tasks associated with a specific page. It is executed during the first loading of a page but no longer during the navigation of it.

The memory consumption related to this processing is negligible (in the order of a few bytes), its output being a table of references pointing directly to the objects describing the tasks of the corresponding page.

This navigator initialization step is shown in FIG. 4. As a result of the preceding step, a pre-interpreted document was obtained. It is determined if the document possesses a page model or not. In the case of a positive response: the first object of said model is positioned upon, whereas in the case of a negative response, the first object of the page to be displayed is positioned upon. In the two aforementioned cases, it should then be determined if said object corresponds to a “keyboard shortcut” or not. If this object indeed corresponds to a “keyboard shortcut”, the position of this object will be saved, linked with a task reference table associated with “keyboard shortcuts”. In the case where said object does not correspond with a “keyboard shortcut”, it is determined if this object is a variable or not. If it is a variable, it is stored. If it is not a variable, it is determined if it is a counter or not. In the case where this object is a counter, the position of said object is saved linked with a reference table of tasks associated with the counters. Then the counter is started.

The next sub-step consists in determining if the object in question is the last object of the model or of the page. The next object of the digital document in question is then attained and the same processing operations will be carried out on this next object, or, if the processed object is the last object of the page, this navigator initialization step is ended, unless this object is the last object in the model, in which case the first object of the page to be displayed is positioned upon and the appropriate processing operations are carried out as described above.

The indications provided in the paragraph above will appear more clearly upon reading the description of the diagram of FIG. 4.

3) Display and Navigation (“Display and Browse”):

This processing operation, shown in FIG. 5, is the most frequently called processing operation. As the operations that are the heaviest users of CPU resources have already been executed previously, its responsiveness for the user is thus optimal.

It consists in:

the displaying of N lines (already previously page formatted) that can be displayed on the screen,

the management of the navigation: Highlighting of objects that can be activated and/or page scrolling,

the execution of tasks when they are invoked: to take up again the example cited above in 1-b, when the user presses the A key, the navigator initialization process (or “Browser init”) will be called to initialize the page “weather card” and the processing operation “Display and browse” will be invoked then to re-launch the navigation within the new page.

The display and navigation processing operation is illustrated in FIG. 5. After display of the page, the first sub-step of this processing operation corresponds to the detection of events. Once an event has been detected, it is determined if said event corresponds to the “validate” key (or to the group of “validation” type keys). In the case of a positive response, whether an object has been selected or not is examined, and, if indeed an object has been selected, the task associated with this object (jump, text modification, activation of options, etc.) is executed in relation with the reference table of tasks associated with selected objects. In the case where said event does not correspond with said “validation” key but with a “direction” type key, the current object is de-selected and the neighbouring object is selected according to the direction indicated, in relation with a reference table of tasks associated with selected objects. In the case where said event corresponds neither with the “validation” key nor with a “direction” type key, but with a key that corresponds to a task shortcut, the execution of said task is continued (jump, text modification, options activation, etc.) in relation with the reference table of tasks associated with the keyboard shortcuts. Finally, it could be that said event is not linked to one of the keys previously cited, but corresponds to the expiration of a counter. In this case, the execution to the task linked to the expiration of said counter (jump, text modification, activation of options, etc.) is proceeded to in relation with the reference table of tasks associated with counters. In all cases, it ends with the updating of the display and waiting then for a new event to be detected.

The indications provided in the paragraph above will appear more clearly upon reading the description of the diagram of FIG. 5.

The invention is described in the preceding text as an example. It is understood that those skilled in the art are capable of producing variants of the invention without leaving the scope of the patent.

1-7. (canceled)

8. Method for preparation of a digital document for the display of said document and the navigation within said document in a mobile device, said display and navigation operations being realized by a computer program, said document comprising a plurality of elements and at least one page wherein it comprises the following steps:
upon the reception of the document: pre-interpretation of the digital document and encoding of a part at least of the elements of said digital document into objects directly exploitable by said computer program,
upon reception of a display command of a page of the digital document: identification of the tasks associated with this page and creation of a reference table pointing directly to the objects describing the tasks of said page, and
displaying of said page comprising a possible highlighting of objects that can be activated and/or a possible scrolling of the page, then execution of the tasks upon request of a user.

9. Method for preparation of a digital document for the display of said document and the navigation within said document according to claim 8, wherein the pre-interpretation step of the digital document and encoding of at least one part of the elements of said digital document is composed of two sub-steps: one of formatting of the display and the other of formatting of the tasks.

10. Method for preparation of a digital document for the display of said document and the navigation within said document according to claim 9, wherein the sub-step of formatting the display consists in page formatting the entire document so that each part of said document can be directly displayed without requiring formatting.

11. Method for preparation of a digital document for the display of said document and the navigation within said document according to claim 8, wherein the pre-interpretation step of the digital document and the encoding of one part at least of the elements of said digital document is executed by applying a rule according to which an object is replaced by another object occupying at most the same space in the memory.

12. Method for preparation of a digital document for the display of said document and the navigation within said document according to claim 9, wherein the pre-interpretation step of the digital document and the encoding of one part at least of the elements of said digital document is executed by applying a rule according to which an object is replaced by another object occupying at most the same space in the memory.

13. Method for preparation of a digital document for the display of said document and the navigation within said document according to claim 10, wherein the pre-interpretation step of the digital document and the encoding of one part at least of the elements of said digital document is executed by applying a rule according to which an object is replaced by another object occupying at most the same space in the memory.

14. Method for preparation of a digital document for the display of said document and the navigation within said document according to claim 8, wherein the overlapping of objects that can be displayed and objects that can not be displayed is saved without having any impact of the functions of display and task identification.

15. Method for preparation of a digital document for the display of said document and the navigation within said document according to claim 8, wherein it comprises a step of suppression of elements from said document that cannot be displayed, or be identified as tasks, and a step of resetting to zero of the corresponding memory space.

16. Method for preparation of a digital document for the display of said document and the navigation within said document according to claim 8, wherein it comprises a step of concatenation of elements framing an unused memory zone.
